(19) United States
(12) Patent Application Publication
(10) Pub. No.: US 2023/0170124 A1
(43) Pub. Date: Jun. 1, 2023

(54) INDUCTANCE VALUE INCREASING STRUCTURE

(71) Applicant: TAI-TECH ADVANCED ELECTRONICS CO., LTD., Taoyuan City (TW)

(72) Inventors: Hsiang Chung Yang, Taoyuan City (TW); Pao Lin Shen, Taoyuan City (TW); Ming-Yen Hsieh, Taoyuan City (TW)

(21) Appl. No.: 17/536,116

(22) Filed: Nov. 29, 2021

(51) Int. Cl. H01F 17/04; H01F 27/29

(52) U.S. Cl. CPC H01F 17/045; H01F 27/292; H01F 2017/048

(57) ABSTRACT

An inductance value increasing structure includes: a magnetic core and a coil. The magnetic core is of an I-shape. The magnetic core includes a central pole. The central pole has two ends that are respectively provided with a first flange and a second flange, and the first flange has a length and a width that are less than or equal to the second flange. The coil has a first end and a second end. The coil is wound around and disposed on the magnetic core. Compared to a known structure, the present invention includes, in addition to a central pole, a first flange. Under a condition of being supplied with one fixed current, the greater the size and shape of the magnetic core, the larger the inductance value of the inductor, and thus, the arrangement of the first flange can effectively increase the inductance value.

### TECHNICAL FIELD OF THE INVENTION

The present invention relates to an inductor, and more particularly to an inductor of which an inductance value is increased by increasing a size of a magnetic core.

### DESCRIPTION OF THE PRIOR ART

Taiwan Patent Publication No. 200826122, “Electronic Component and Related Method Thereof”, includes, as shown in FIG. 1 of the patent document, a flat end magnetic core, an electrically conductive element, and terminals. The patent document provides a flange on only one end of a central pole, but does not provide flanges on both ends of the central pole.

For an inductor, the size of the magnetic core affects the inductance value. The larger the magnetic core, the larger the inductance value, and conversely, the smaller the magnetic core, the smaller the inductance value. Thus, there is still room for improvement for the prior art.

### SUMMARY OF THE INVENTION

To achieve the above purpose, the present invention provides an inductance value increasing structure, which comprises a magnetic core and a coil. The magnetic core is of an I-shape. The magnetic core comprises a central pole. The central pole has two ends that are respectively provided with a first flange and a second flange. The first flange has a length and a width that are less than or equal to the second flange. The coil has a first end and a second end. The coil is wound around and disposed on the magnetic core.

In the above structure, the central pole is of a shape that is one of a rectangle, a polygon, and a cylinder.

In the above structure, the magnetic core comprises ferrite or a soft magnetic material.

In the above structure, outside of the magnetic core and the coil is enclosed by a package body.

In the above structure, the magnetic core is made of manganese-zinc ferrite.

In the above structure, the coil is formed of a circular wire or a flat wire. In the above structure, the first end and the second end of the coil are extended outward from the magnetic core two form two terminals.

In the above structure, the first end and the second end of the coil are extended outward from the magnetic core and are each connected with a metal plate two form two terminals.

In the above structure, the coil comprises multiple turns and multiple layers.

In the above structure, the coil is formed of an α-winding structure wound around and disposed on the magnetic core.

The present invention includes, in addition to a central pole, a first flange. Under a condition of being supplied with one fixed current, the greater the size and shape of the magnetic core, the larger the inductance value of the inductor, and thus, the arrangement of the first flange can effectively increase the inductance value.

### BRIEF DESCRIPTION OF THE DRAWINGS

FIG. 1 is a schematic view showing an inductance value increasing structure according to the present invention.

FIG. 2 is a schematic view showing a central pole having a polygonal form.

FIG. 3 is a schematic view showing a central pole having a cylindrical form.

FIG. 4 is a schematic view showing a magnetic core and a coil enclosed by a package body on the outside.

FIG. 5 is a schematic view showing a first end and a second end of a coil directly forming two terminals.

FIG. 6 is a schematic view showing a first end and a second end of a coil connected to metal plates to then form two terminals.

FIG. 7 is a schematic view showing a coil formed of a flat wire.

FIG. 8 is a schematic view showing a circular wire wound to form multiple turns and multiple layers.

FIG. 9 is a schematic view showing a flat wire wound to form multiple turns and multiple layers.

### DETAILED DESCRIPTION OF THE PREFERRED EMBODIMENT

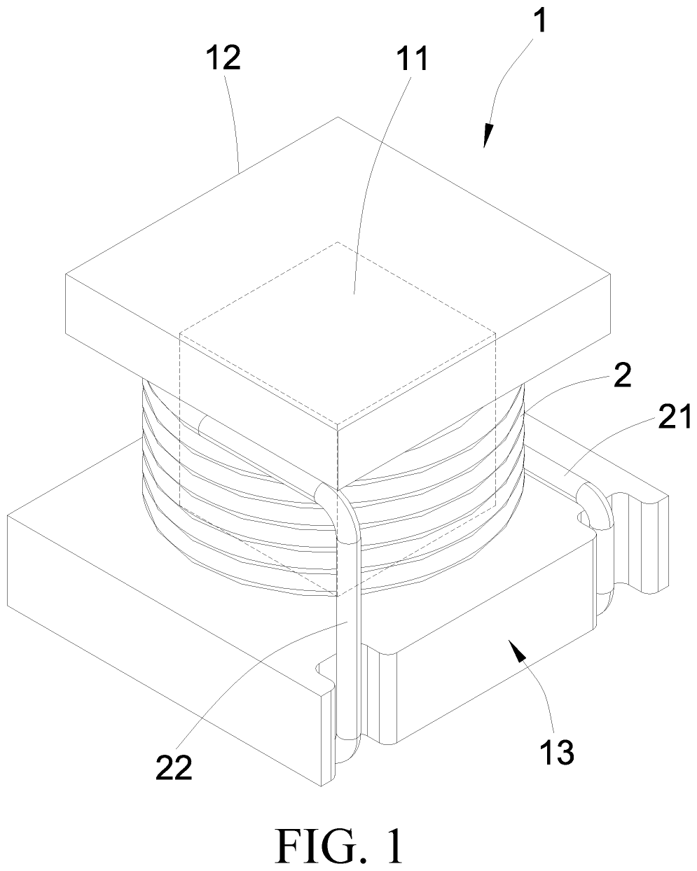

Referring to FIG. 1, the present invention provides an inductance value increasing structure, which comprises: a magnetic core 1 and a coil 2.

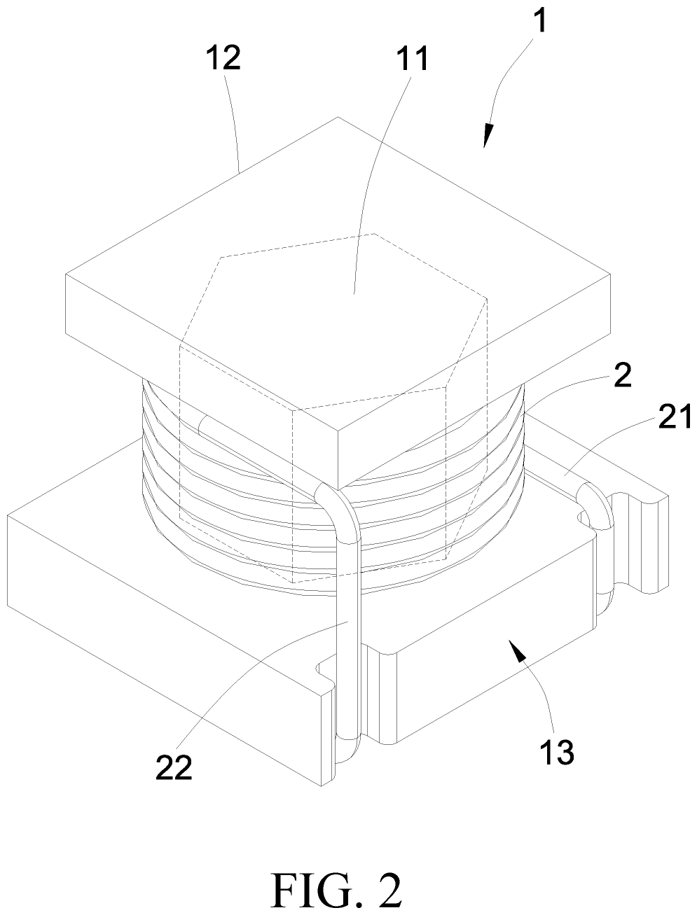

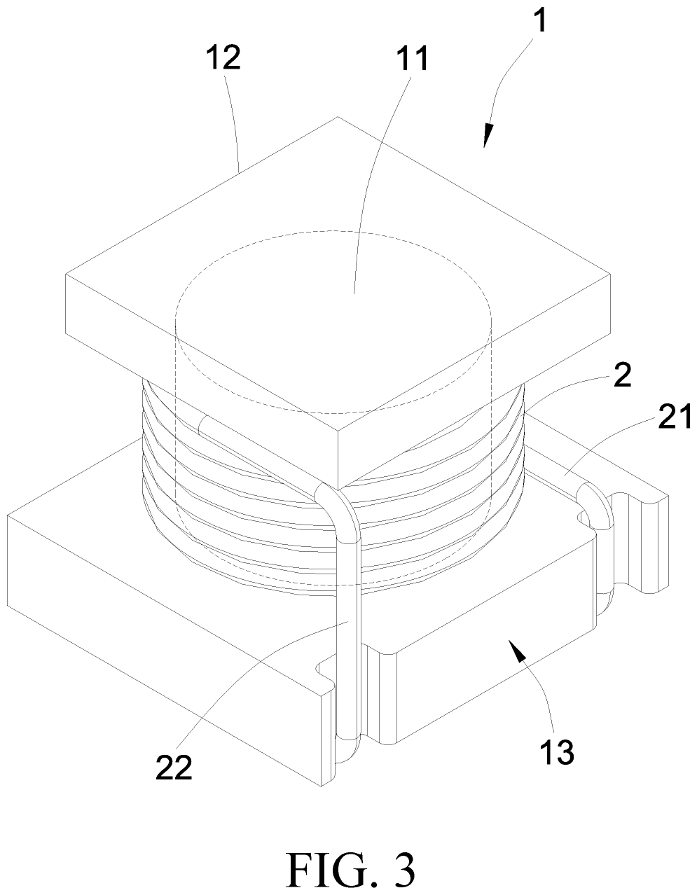

The magnetic core 1 is of an I-shape. The magnetic core 1 comprises a central pole 11. The central pole 11 has two ends that are respectively provided with a first flange 12 and a second flange 13. The first flange 12 has a length and a width that are less than or equal to those of the second flange 13. Referring to FIGS. 1, 2, and 3, the central pole 11 can be of a shape that is a rectangle (see FIG. 1), a polygon (see FIG. 2), or a cylinder (see FIG. 3). The magnetic core 1 is made of a magnetic material. The magnetic core 1 can be of ferrite or a soft magnetic material. Ferrite is a nonmetallic magnetic material, and generally, ferrite is a composite oxide formed of one or multiple metallic elements, with iron being the primary element. For example, the magnetic core 1 can be made of manganese-zinc ferrite.

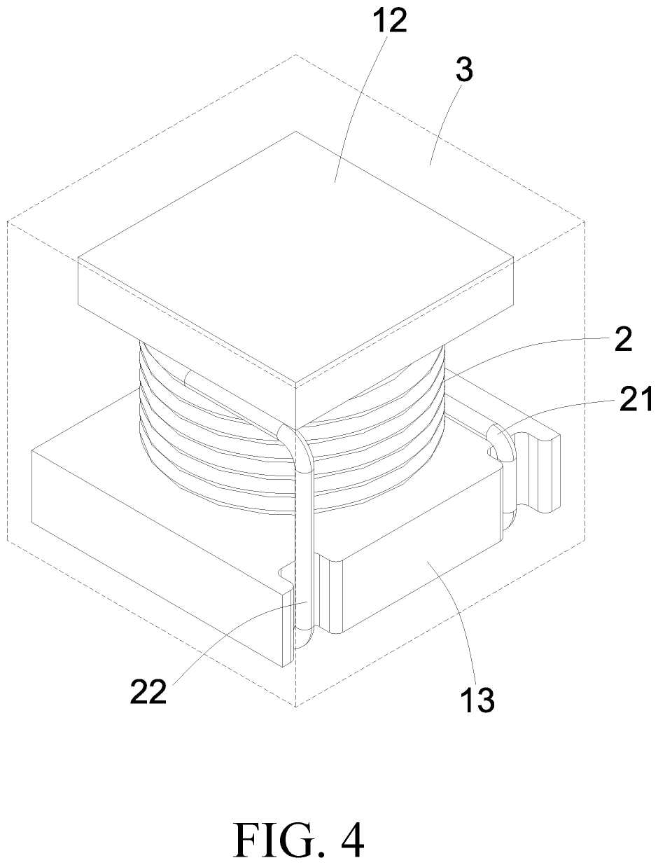

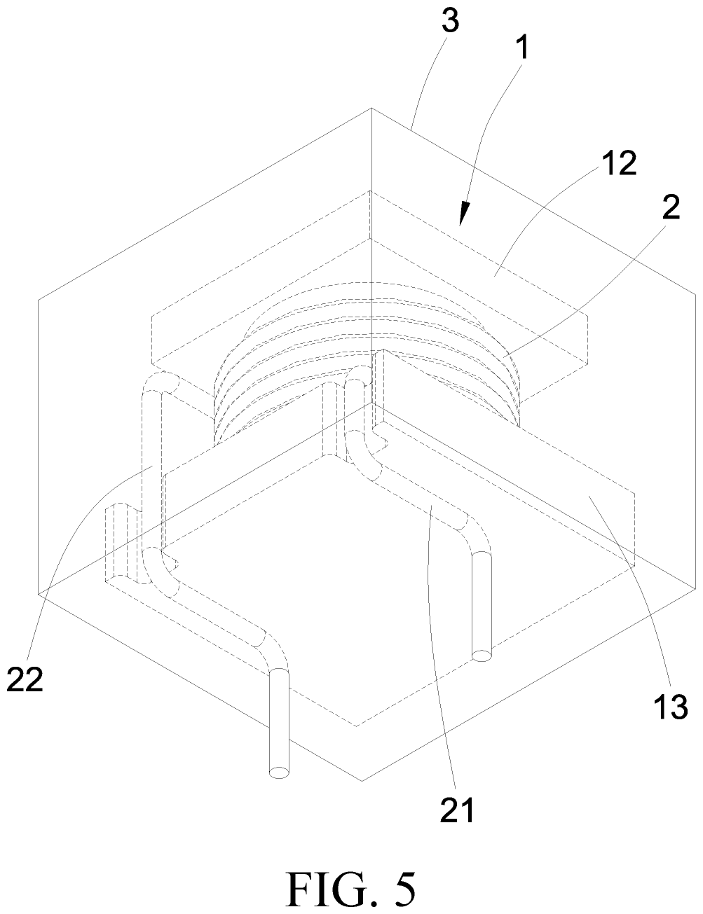

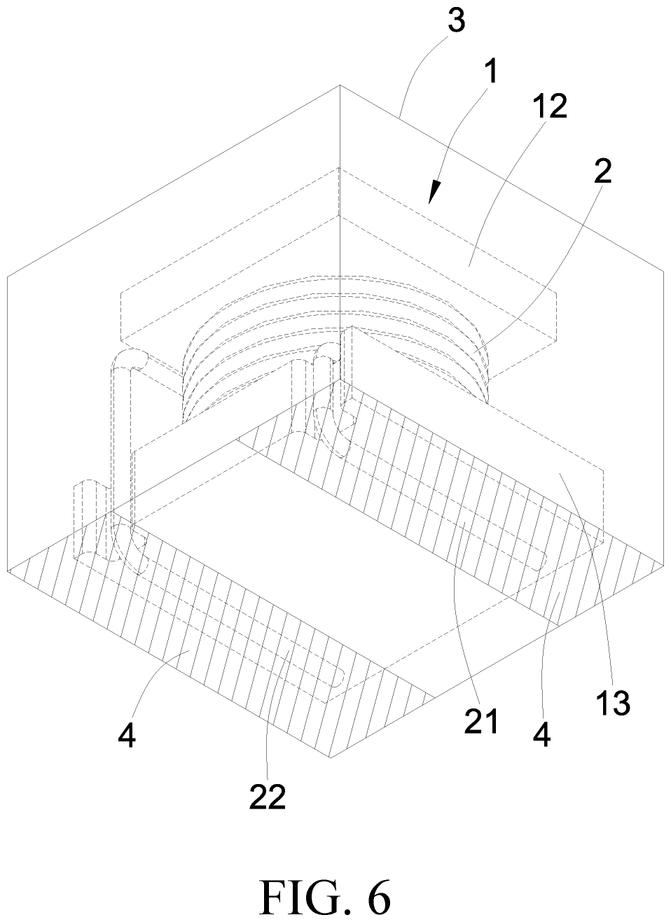

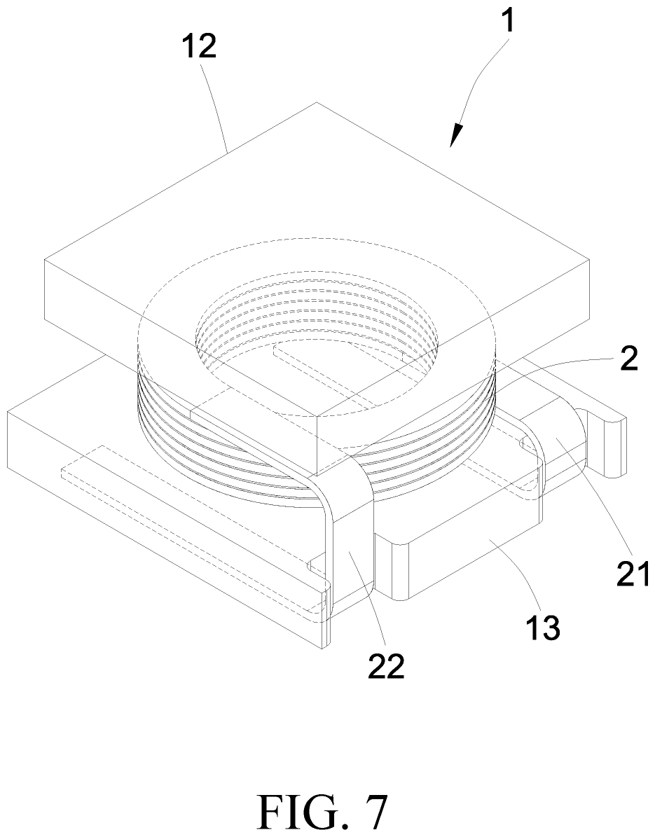

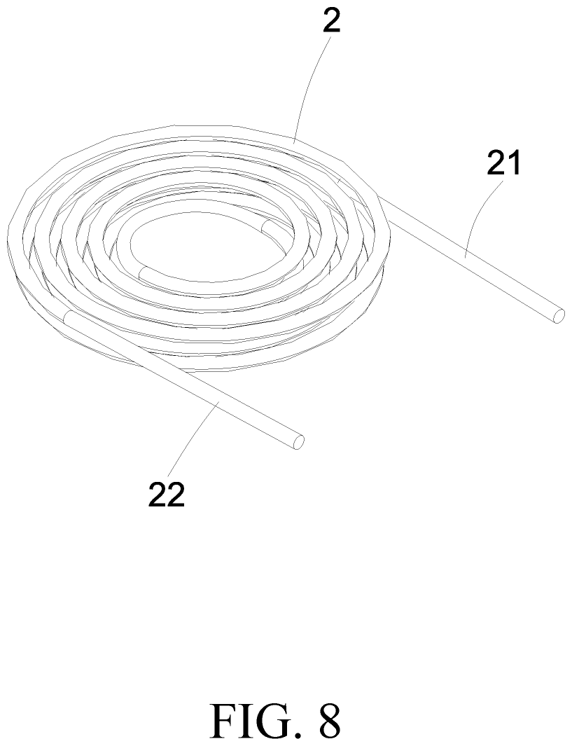

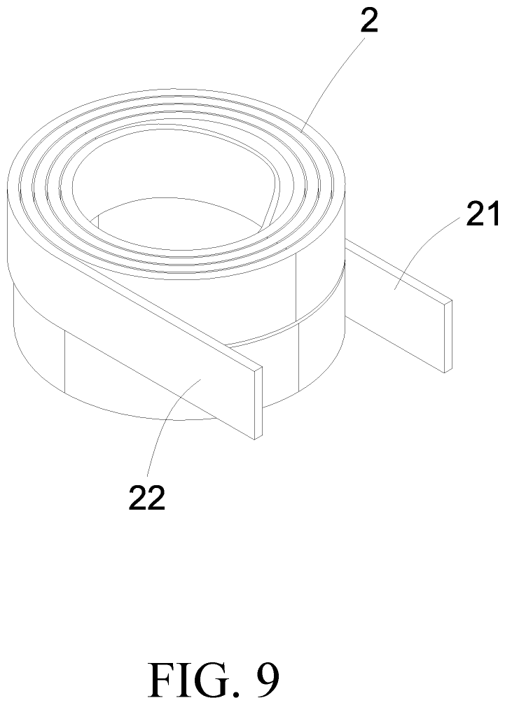

The coil 2 has a first end 21 and a second end 22. The coil 2 is wound around and disposed on the magnetic core 1. The coil 2 can be formed of a circular wire (see FIG. 1) or a flat wire (see FIG. 7). Referring to FIG. 4, the magnetic core 1 and the coil 2 are enclosed by a package body 3 on the outside. The package body 3 is made of a plastic material or a composite plastic material. The package body 3 is formed by the injection molding technology to have a predetermined size for enclosing a periphery of the magnetic core 1 and the coil 2 to form the package body 3. It only requires an overall side of the magnetic core 1 and the coil 2 be smaller than the package body 3, and there is no limit to the shape of the magnetic core 1 or the number of sets of the coil 2. Further, the package body 3 offers protection to the magnetic core 1 and the coil 2, and further fixing terminals (or electrodes) that are extended out of the package body 3 to prevent them from curving or breaking due to an external force and resulting in undesired issues of shorting and abnormal conducting. Referring to FIG. 5, the first end 21 and the second end 22 of the coil 2 are extended outward from the magnetic core 1 and penetrate through the package body 3 to form two terminals (electrodes) respectively, meaning the first end 21 and the second end 22 of the coil 2 serve as terminals. Or alternatively, referring to FIG. 6, the first end 21 and the second end 22 of the coil 2 are extended outward from the magnetic core 1 and are each connected to a metal plate 4 extending out of the package body 3 to form two terminals (electrodes), meaning the first end 21 and the second end 22 of the coil 2 are each connected to a metal plate 4 first, and the metal plates 4 serve as the terminals. The terminals (electrodes) are exposed outside the package body 3 in order to electrically connect with other circuit boards or other electronic components. The coil 2 can be of multiple turns and multiple layers. For example, a circular wire can be wound to form the multiple turns and multiple layers (see FIG. 8) a flat wire can be wound to form the multiple turns and multiple layers (see FIG. 9). The coil 2 may also possibly adopt an α-winding structure to wind around the magnetic core 1. The α-winding structure is so named because the winding structure is of a shape looked like the letter a. The inductance value is proportional to the square of the number of turns, and thus, forming the coil 2 as being wound in multiple turns around the magnetic core 1 can increase the inductance value. Similarly, forming the coil 2 as being wound in multiple layers can also increase the inductance value.

The present invention is structured to include, in addition to a central pole 11, a first flange 12. Under a condition of being supplied with one fixed current, the greater the size and shape of the magnetic core 1, the larger the inductance value of the inductor, and thus, the arrangement of the first flange 12 can effectively increase the inductance value.

I claim:

1. An inductance value increasing structure, comprising:
a magnetic core, which is of an I-shape, the magnetic core comprising a central pole, the central pole having two ends that are respectively provided with a first flange and a second flange, the first flange having a length and a width less than the second flange; and
a coil, which has a first end and a second end, the coil being wound around and disposed on the magnetic core.

2. The inductance value increasing structure according to claim 1, wherein the central pole is of a shape that is one of a rectangle, a polygon, and a cylinder.

3. The inductance value increasing structure according to claim 1, wherein the magnetic core comprises ferrite or a soft magnetic material.

4. The inductance value increasing structure according to claim 1, wherein outside of the magnetic core and the coil is enclosed by a package body.

5. The inductance value increasing structure according to claim 1, wherein the magnetic core is made of manganese-zinc ferrite.

6. The inductance value increasing structure according to claim 1, wherein the coil is formed of a circular wire or a flat wire.

7. The inductance value increasing structure according to claim 1, wherein the first end and the second end of the coil are extended outward from the magnetic core two form two terminals.

8. The inductance value increasing structure according to claim 1, wherein the first end and the second end of the coil are extended outward from the magnetic core and are each connected with a metal plate two form two terminals.

9. The inductance value increasing structure according to claim 1, wherein the coil comprises multiple turns and multiple layers.

10. The inductance value increasing structure according to claim 1, wherein the coil is formed of an α-winding structure wound around and disposed on the magnetic core.
